(19) United States
(12) Patent Application Publication
(10) Pub. No.: US 2008/0250308 A1
(43) Pub. Date: Oct. 9, 2008

(54) Method for communicating images and forms in a medical environment

(76) Inventors: Renee Cheung Walsh, Wilton, CT (US); Scott Keller, Mt.Prospect, IL (US); John Thomas McGibbon, Altamont Springs, FL (US)

Correspondence Address: Jordan C. Powell;Powell and Associates, 243 N. Bald Mountain Dr., Alpine, UT, 84004, US

(21) Appl. No.: 11/818,952

(22) Filed: Nov. 24, 2006

(51) Int. Cl. G06F 17/00

(52) U.S. Cl. 715/223

(57) ABSTRACT

The present invention discloses a method for customizing forms of a medical information data base system to meet the needs of a specific medical practice where the needs includes conditions such as types of medical situations encountered, types of patients. The forms are linked to data and images, such as radiology images, that are stored within the data base system. By storing the customized forms in the data base system they are available for future recall. These forms supply necessary information and images upon user input of required criteria that are needed for analysis of a patient and the practitioner's diagnosis.

### BACKGROUND OF THE INVENTION

1. Field of the Invention

This invention relates to the field of communicating medical information, and more particularly relates to creation, modification, retention and communication of forms containing medical information.

2. Description of the Related Art

Advancing technology within the medical arena requires advancing tools to manage images such as radiology pictures and to manage client records. These images and clients records are critical to helping a medical practitioner generate the proper prognosis and determine an appropriate treatment. For instance a practitioner will often review X-rays of a patient, the patient's medical history and the patient's family history before narrowing down a diagnosis of the patient's ailment. The practitioner will further ask specific questions of the patient to help in that diagnosis.

Increasing world population, increasing awareness of health, and increasing capabilities by the medical industry equates to increasing demands on a practitioner to understand and manage growing volumes of information. This is true particularly with hospitals where the number of patients is often very large and the practitioners working with the hospitals are vast. In an environment such as a hospital there is a tremendous need for multiple practitioners to have access to records and images of a single patient. On the other hand, even a small practice doctor requires immediate access to information related to the doctor's patients.

To address the need of critical information sharing among practitioners, various tools have been developed allowing transmission of critical information. Some standards for transmitting information have been established such as RIS (Radiology Information System) and HIS (hospital Information System) in order to bring transmission consistency to the vast amount of information shared. For instance, a leading system for PACS (Picture Archiving and Communication Systems) designed by FujiFilms called Synapse was developed to allow transmission of radiology pictures. Other systems have also been developed for the market.

A significant problem associated with the current systems is inflexibility. A practitioner will be required to utilize forms set up for a broad reaching audience, a blanket set of forms, without the ability to truly customize its RIS/HIS system to the needs of the practitioner, the practitioner's patients, or the locality.

### SUMMARY OF THE INVENTION

The present invention has been developed in response to the present state of the art, and in particular, in response to the problems and needs in the art that have not yet been fully solved by the RIS, HIS and other medical form systems currently available. Accordingly, the present invention has been developed to provide a method for communicating images and messages in the medical field that overcome the above-discussed shortcomings in the art.

The present invention allows a user to customize medical forms which are normal very rigid in application and cover a very large scope of medical practices. The customization allows a practitioner to apply forms to a local practice. For instance, a practitioner having a rural and small medical practice will not have many of the cases found within a large emergency care center in a big city environment, nor will an ear, nose and throat practice want similar forms as a practice focusing on OB/GYN practice. The customized forms are stored within the practitioner's data storage system for future use. These forms, in their customized state, are designed to prompt the practitioner to help in the diagnosis. To do so, the forms are linked to information and images also stored within the data storage system and such additional information is readily available to assist the practitioner.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows a screen shot according to an embodiment of the present invention;

FIG. 2 shows a screen shot derived by selecting an option within the screen shot of FIG. 1 according to an embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

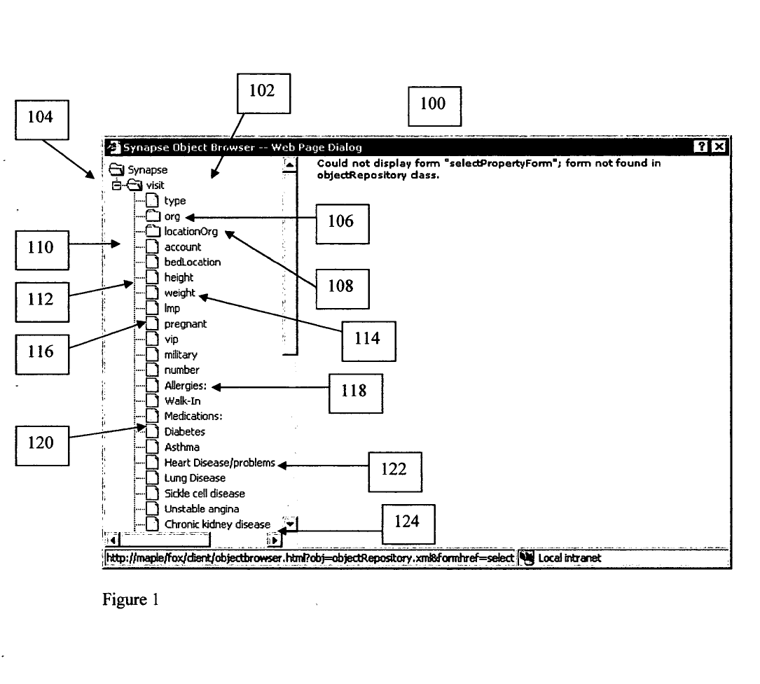

FIG. 1 shows a screen shot 100 of an exploration tree 102 according to a first embodiment of the present invention. An exploration tree according to this embodiment means a listing of various causes, diseases, or actions to be studied or taken. For instance, what is shown in screen shot 100 is a listing of many of the issues that can be considered for a patient's visit 102 to the doctor or medical practitioner. The embodiment of screen shot 100 indicates the FujiFilm Synapse system 104 is being utilized. However it will be recognized that the present invention applies to all similar medical information systems.

The visit file 102 includes documents and other files. For instance, examples of files included within visit file 102 could be a file of organization 106 or location 108. Additionally, specific documents could include information on the patient's account 110, a patient's height 112 or weight 114, whether the patient is pregnant 116 or has allergies 118. Further documents would include information on specific diseases that should be considered in the doctor/practitioner's diagnosis such as diabetes 120, heart disease 122, kidney disease 124 etc. What is to be understood by one having ordinary skill in the art is that each of these documents contains information necessary to accomplish specific purposes. Easily grasped would be the fact that account 110 would include information on a patient's past and pending account, whether amounts are outstanding and what current charges contain. All of this type of information would be available within account 110. Further it should be understood that these documents are generally dynamic forms that can be modified as situations require.

Documents/forms on various medical conditions are also dynamic meaning they can be modified, expanded, or even removed depending upon circumstances. Further, the types of conditions are not limited or static. This means that new documents/forms can be created and added to the list of selections where additional illnesses or conditions are needed. For example, a new document/form may be needed due to emergence of a new and particularly harmful virus such as the emergence as a threat to the public of the avian virus.

One having ordinary skill in the art will recognize that visit 102 would not be the only type of main file within a system. Innumerable files could be populated within the main list with each file having sub-files and related documents similar to how visit 102 is populated. What is important pursuant to the present invention is flexibility and expandability allowing the system to be modified to fit the use and environment. In other words, the present invention allows a system administrator within a hospital to add new forms and files and modify existing ones. It will be noted that the forms are stored in the system data base for retrieval at any point. Further, finished forms for specific patients will be stored with the patient's personal file.

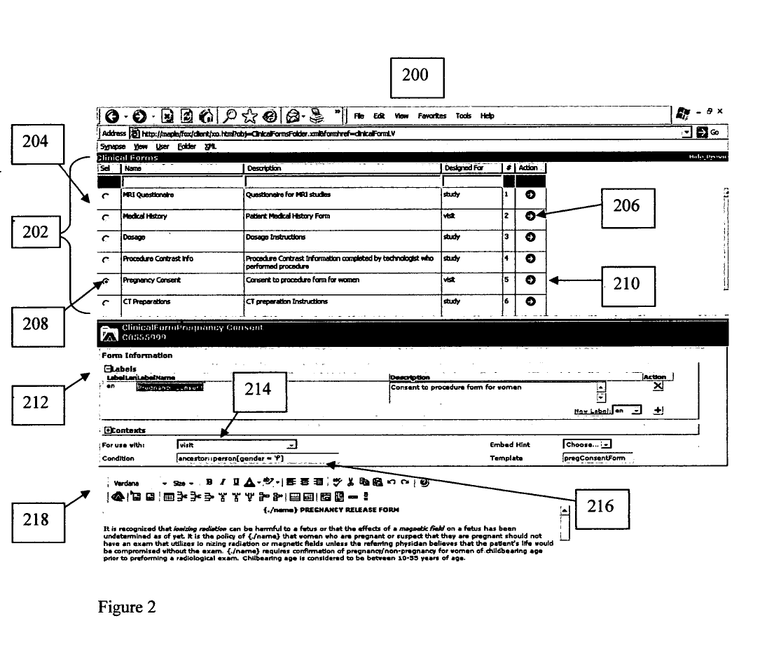

FIG. 2 shows a screen shot of one of the forms of FIG. 1. Specifically, a user has selected the pregnant document/form 116 yielding the screen shot 200 of FIG. 2.

Referring now to FIG. 2, the pregnant 116 form of FIG. 1 is shown in a manner in which the practitioner/doctor can evaluate the patient's condition and analyze the proper diagnosis. Specifically a screen designated by 202 is shown to the doctor. Screen 202 shows various options from the pregnant form from which the doctor can select. For instance, the doctor may desire to view the patient's medical history before proceeding with any further testing or diagnosis. Accordingly, the doctor would select a “sel” button 204 next to the option “Medical History”. The doctor then selects the “Action” button 206 associated with the “Medical History” and a screen showing the patient's history would appear in a partial screen immediately below screen 202.

In FIG. 2 a user has selected “Pregnancy Consenf” select button 208 and subsequently the associated “Action” button 210. This brings up in split screen mode the pregnancy consent form 212. It can be seen from form 212 of FIG. 2 that many options are available and the options are tailored to the specific practice of the practitioner. For instance, window 214 allows the practitioner to identify an object for which this form is associated. In this case, the practitioner has indicated that the form is part of an office visit by the patient. Other types may include emergencies such as where a pregnancy test may need to be conducted on a woman harmed in an accident or other such situation. It can be seen how such options would need to be tailored to the practitioner's specific practice. For instance, an emergency would be a common option within a hospital but may not be such in a family practice office. Other options of the form would include necessary conditions such as found in window 216. As example, a necessary condition for a pregnancy test would be that the patient is female and that would be selectable within window 216. Note that by inputting a necessary condition other conditions and/or options are molded or driven by the input necessary condition. For instance, inputting “female” into the necessary condition of window 216 would eliminate options requiring tests performed only on male patients or tests that are not applicable to men.

A major portion of screen 212 is a memo and analysis portion 218. Here the practitioner has the ability to first scan through a data base of potential questions, diagnosis, etc. by selecting the button 220. This selection will bring up information which the practitioner will need in order to make a diagnosis of the patient. The practitioner is also able to generate notes necessary for records and follow up work which is stored in the patient's file. An additional option is the ability for the practitioner to attach physically generated documents to the form, such as attaching a pdf of the patient's signature, or linking the form to images of the patient such as X-rays.

Important to the present invention, and as has been outlined in the explanation above, is the ability of the practitioner to modify, add, delete and store various forms within the practitioner system, in addition to linking the form(s) to other parts of the system including the imaging system. The present invention allows the practitioner to customize the forms, questions and diagnosis options to the resident practice.

Although the description of the present invention has utilized various embodiments, it will be recognized that the present invention is not limited to the specific embodiments described. Rather, the present invention encompasses all variants incorporating the essence of the ideas presented in the above description.

What is claimed is:

1. A method comprising:
customizing forms of a medical information data base system to meet the needs of a specific medical practice, the needs including conditions such as types of medical situations encountered, types of patients, and further linked to data and images, such as radiology images, that are stored within the data base system;
storing the customized forms in the data base system for future recall; and
recalling the forms for utilization, the forms supplying necessary information and images upon user input of required criterias.
